(19) United States
(12) Patent Application Publication
(10) Pub. No.: US 2019/0347599 A1
(43) Pub. Date: Nov. 14, 2019

(54) SYSTEMS AND METHODS FOR ROUTING SUPPORT TICKETS

(71) Applicant: Palantir Technologies Inc, Palo Alto, CA (US)

(72) Inventors: Zachary Fry, Raritan, NJ (US); Mohammad Bukhari, Palo Alto, CA (US); Ashley Ng, Alexandria, VA (US); Cody Moore, Menlo Park, CA (US); Christopher Tschinkel, San Francisco, CA (US); Nathanial Newman, Palo Alto, CA (US); Roman Myers, Palo Alto, CA (US); Yiwei Gao, Palo Alto, CA (US); Zachary Alberico, Palo Alto, CA (US)

(21) Appl. No.: 15/991,263

(22) Filed: May 29, 2018

Related U.S. Application Data
(60) Provisional application No. 62/668,671, filed on May 8, 2018.

(51) Int. Cl. G06Q 10/06; G06F 15/18

(52) U.S. Cl. CPC G06Q 10/063112; G06F 3/04842; G06F 15/18

(57) ABSTRACT

Systems and methods are provided for routing support tickets. The system may be configured to receive a support ticket. Metadata information corresponding to the support ticket may be obtained by the system. The metadata information may indicate at least one component associated with the support ticket. Based on the metadata information corresponding to the support ticket and respective attributes associated with the first entity, the system may be configured to assign the support ticket to at least a first entity. Assigning the support ticket to at least the first entity may include providing a list of one or more entities that are eligible for assignment, determining a user selection of the first entity through an interface, and storing a record of the support ticket being assigned to the first entity.

### CROSS REFERENCE TO RELATED APPLICATIONS

This application claims the benefit under 35 U.S.C. § 119(e) of U.S. Provisional Application Ser. No. 62/668,671, filed May 8, 2018, the content of which is incorporated by reference in its entirety into the present disclosure.

### TECHNICAL FIELD

This disclosure relates to information routing. In particular, this disclosure relates to approaches for automatically routing support tickets.

### BACKGROUND

Under conventional approaches, support tickets can be assigned to employees within an organization based on which employees are available. This may create problems in global organizations where employees or teams that are able to address the issue may be located in different time zones and/or have different work schedules. Often, support tickets can be routed incorrectly (e.g., to the wrong team or employee) and employees have to spend time and resources re-routing the support ticket. In some instances, support tickets may be routed to an employee that may not be available or working thereby delaying resolution of the support tickets.

### SUMMARY

Various embodiments of the present disclosure can include systems, methods, and non-transitory compute readable media configured to receive a support ticket; obtain metadata information corresponding to the support ticket, the metadata information indicating at least one component associated with the support ticket; and assign the support ticket to at least a first entity based at least in part on the metadata information corresponding to the support ticket and respective attributes associated with the first entity.

In some embodiments, the systems, methods, and non-transitory computer readable media are configured to provide a list of one or more entities that are eligible for assignment, the one or more entities including the first entity; determine a user selection of the first entity through an interface; and store a record of the support ticket being assigned to the first entity.

In some embodiments, the systems, methods, and non-transitory computer readable media are configured to determine the first entity based at least in part on a machine learning model.

In some embodiments, the machine learning model is trained using a set of training examples that each include a set of metadata values provided for a given support ticket as inputs, and information describing one or more entities or teams to which the support ticket was assigned as a supervisory signal.

In some embodiments, the machine learning model outputs a prediction for assigning the support ticket to the first entity based at least in part on metadata values associated with the support ticket.

In some embodiments, the metadata values include at least one of a support issue type, priority, product or component affected, product or component version, security level requirement, and a description of a problem to be addressed by the support ticket.

In some embodiments, the attributes associated with entities include time zone information, geographical location information, work schedule information, and/or calendar information.

In some embodiments, the systems, methods, and non-transitory computer readable media are configured to determine a first team based at least in part on the component associated with the support ticket and respective attributes associated with the first team; provide a list of one or more entities within the first team that are eligible for assignment, the one or more entities including the first entity; determine a user selection of the first entity through an interface; and store a record of the support ticket being assigned to the first entity.

In some embodiments, the systems, methods, and non-transitory computer readable media are configured to determine a first team based at least in part on the metadata information corresponding to the support ticket and respective attributes associated with the first team; determine a first unit based at least in part on the metadata information corresponding to the support ticket and respective attributes associated with the first unit; provide a list of one or more entities within the first unit that are eligible for assignment, the one or more entities including the first entity; determine a user selection of the first entity through an interface; and store a record of the support ticket being assigned to the first entity.

These and other features of the systems, methods, and non-transitory computer readable media are disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention(s).

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention(s) are utilized, and the accompanying drawings of which:

FIG. 1 depicts a diagram of an example of a system for routing support tickets, in accordance with various embodiments.

FIG. 2 depicts a diagram of an example of a support ticket assignment engine, in accordance with various embodiments.

FIG. 3A depicts an example process for routing support tickets, in accordance with various embodiments.

FIG. 3B depicts an example interface for visualizing and/or receiving work schedule information, in accordance with various embodiments.

FIG. 3C depicts an example interface for routing support tickets, in accordance with various embodiments.

FIG. 4 depicts a flowchart of an example method for routing support tickets, in accordance with various embodiments.

FIG. 5 depicts a block diagram of an example computer system in which any of the embodiments described herein may be implemented.

### DETAILED DESCRIPTION

A claimed solution rooted in computer technology provides a technological improvement over existing implementations of routing information (e.g., support tickets) across an organization. In various embodiments, information, such as support tickets, may be routed to entities based on various criteria. For example, a support ticket may be routed to a given entity based on one or more attributes associated with the entity including, for example, schedules associated with the entity, a time zone in which the entity resides, and/or a product (or component) assigned to the entity, among other criteria. In some instances, individual entities may be assigned to one or more teams within an organization. Schedule information for the individual entities assigned to various teams may be received by the system via a schedule interface. The individual teams may be responsible for handling support tickets associated with individual components. A given team, for example, may handle support tickets that are related to a given component and/or have a given priority. The system may receive support tickets and identify the components with which they are associated. Metadata information (or metadata values) corresponding to a support ticket may indicate the component associated with the support ticket and be used to determine which component a given support ticket is associated with. A team to which the support ticket should be routed may be identified based on the metadata information indicating the component the support ticket is associated with. Different teams may handle support tickets for different components of a product, service, and/or platform. One or more entities on the identified team that the support ticket should be assigned to may be determined based on the schedule information. The system may effectuate presentation of information describing the one or more individual entities determined based on the schedule information within a graphical user interface. The system or another user may select one or more entities to assign the support ticket to. For instance, the one or more entities may be selected by the system according to an algorithm or by a user such as a team leader. Responsive to selecting or receiving input indicating selection of the one or more entities that should be assigned to the support ticket, a record of the support ticket being assigned to the one or more entities may be stored. In some embodiments, the system may train and use a machine learning model to assign support tickets to entities. For example, in some embodiments, metadata information (or metadata values) describing a support ticket may be provided by a user that created the support ticket. Such metadata information may include information (or cues) such as support issue type, priority, product (or component) affected, product (or component) version, security level (or clearance) needed, and/or a description of the problem to be addressed, among other information. In some embodiments, such information may be used to train a machine learning model. For example, the training data may include examples that each include metadata information associated a respective support ticket as inputs along with information describing entities (or teams) to whom the support ticket was assigned as a supervisory signal. Once trained, the model may receive metadata information associated with a given support ticket as input and may predict one or more entities (or teams) to whom the support ticket should be assigned. Many other variations are possible.

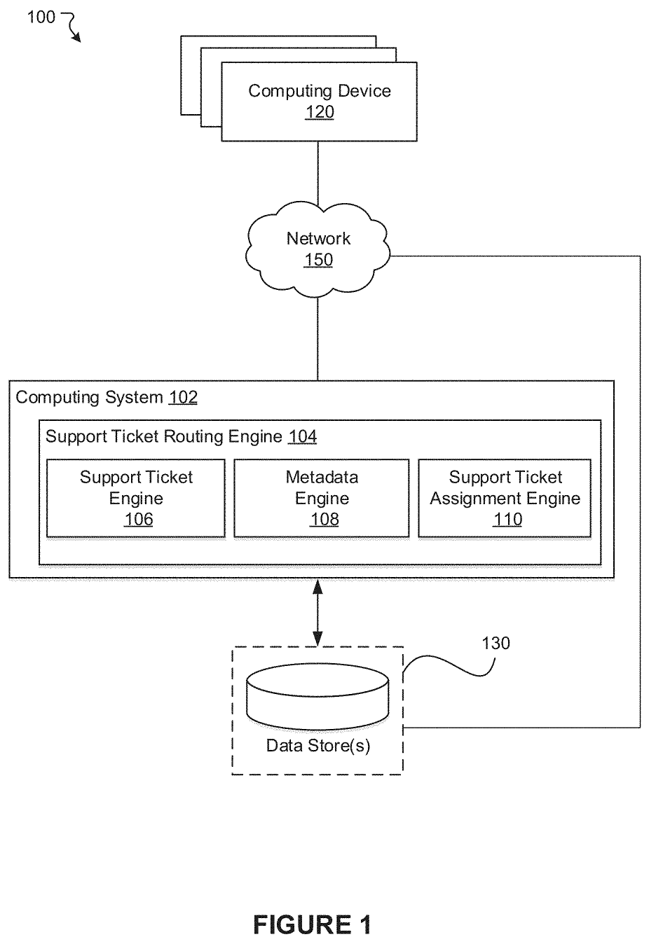

FIG. 1 illustrates an example environment 100, in accordance with various embodiments. The example environment 100 may include at least one computing system 102 that includes one or more processors and memory. The processors may be configured to perform various operations by interpreting machine-readable instructions. In some embodiments, the example environment 100 may be implemented as a support ticket platform. In some embodiments, the example environment 100 may be configured to interact with computing systems of a support ticket platform. In various embodiments, computing systems of the support ticket platform may receive, obtain, and/or otherwise acquire, and route support tickets.

In some embodiments, the computing system 102 may include a support ticket routing engine 104. The support ticket routing engine 104 may include a support ticket engine 106, a metadata engine 108, and a support ticket assignment engine 110. The support ticket routing engine 104 may be executed by the processor(s) of the computing system 102 to perform various operations including those operations described in reference to the support ticket engine 106, the metadata engine 108, and the support ticket assignment engine 110. In general, the support ticket routing engine 104 may be implemented, in whole or in part, as software that is capable of running on one or more computing devices or systems. In one example, the support ticket routing engine 104 may be implemented as or within a software application running on one or more computing devices (e.g., user or client devices) and/or one or more servers (e.g., network servers or cloud servers). In some instances, various aspects of the support ticket routing engine 104, the support ticket engine 106, the metadata engine 108, and the support ticket assignment engine 110 may be implemented in one or more computing systems and/or devices.

The environment 100 may also include one or more data stores 130 accessible to the computing system 102. The data stores 130 may be accessible to the computing system 102 either directly or over a network 150. In some embodiments, the data stores 130 may store data that may be accessed by the support ticket routing engine 104 to provide the various features described herein. For example, as mentioned, the data stores 130 may store scheduling data based on which support tickets may be assigned to entities.

The support ticket engine 106 may be configured to receive (or obtain) support tickets. In some embodiments, the support ticket engine 106 may be configured to receive or obtain support tickets in the form of a message, a filled in form, a document, a field within a support queue, a record, and/or other medium. For example, the support ticket engine 106 may be configured to receive support tickets submitted and/or generated by one or more consumers (or users). In various embodiments, the support ticket engine 106 may route received and/or obtained support tickets to one or more entities that are tasked with processing the support tickets. For example, support tickets may be generated responsive to users having problems or questions related to one or more components of various products.

In some embodiments, metadata engine 108 may be configured to obtain metadata information corresponding to received and/or obtained support ticket(s). In general, metadata information associated with a given support ticket may indicate the purpose and/or goal of the support ticket. The metadata information may include a timestamp indicating when the support ticket was received and/or obtained by the support ticket platform. In some embodiments, the metadata information may include metadata values. For example, the metadata values may include one or more of a support issue type, priority, product or component affected, product or component version, security level requirement, description of a problem to be addressed by the support ticket, and/or other metadata values.

The metadata values may be used to determine one or more teams, units, and/or entities to assign the support ticket to. By way of non-limiting example, the metadata information associated with a support ticket may indicate a first component to be addressed by the support ticket. In some embodiments, the first component indicated by the metadata values may be used to match the support ticket with a team that is responsible for and/or capable of handling support tickets related the first component. In some embodiments, teams may be made up of multiple units (e.g., sub-teams) that are tasked with processing one or more particular components of a product that is supported by the team in general. In some embodiments, the metadata values may also be used to determine a first unit within the first team, for example, based on attributes associated with the first unit. The first unit may include multiple entities (e.g., personnel, resources, support engineers, etc.). In some embodiments, the first unit can be determined based on a time zone and/or geographical information. In some embodiments, the first unit can be determined based on work schedule information and/or calendar information to determine one or more entities included in the first unit that are eligible for assignment. For example, a support ticket may be associated with metadata values that indicate the support ticket was created for an issue with a particular product component and that the support ticket was created by a user residing in New York. In this example, the attributes of the first team may indicate the first team handles (e.g., addresses, fixes, responds to, and/or otherwise handles) support tickets associated with the particular product component. Further, the attributes of the first unit may indicate the first unit handles support tickets within the Eastern time zone. As such, the support ticket created by the user residing in New York may be routed to an entity that belongs to the first unit.

In some embodiments, metadata values corresponding to a given support ticket may be used to train a machine learning model. A set of example support tickets and their corresponding metadata values may be used to train the machine learning model. Each support ticket within the set of examples may include a set of metadata values. The set of metadata values for each support ticket may be provided as inputs for the machine learning model. Information describing one or more teams, units, and/or entities to which each of the support tickets were assigned may be used as a supervisory signal. For example, the machine learning model may be configured to output a prediction for assigning a support ticket to a first entity based at least in part on metadata values associated with the support ticket. Many variations are possible.

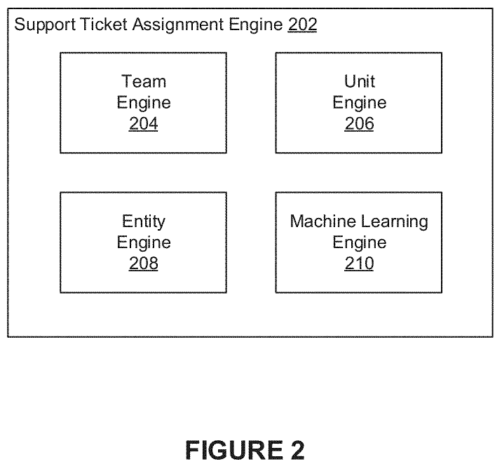

The support ticket assignment engine 110 may be configured to assign (or route) support tickets to various teams, units, or entities based on metadata information. In various embodiments, a support ticket may be assigned to a first entity based at least in part on metadata information corresponding to the support ticket and respective attributes associated with the first entity. The respective attributes associated with the first entity may include one or more of: a team the first entity belongs to, a unit the first entity is part of, the support issue types handled by the first entity, one or more priorities handled by the first entity, one or more products or components handled by the first entity, the product or component version(s) handled by the first entity, a security level of the first entity, time zone information for the first entity, geographical location information for the first entity, work schedule information for the first entity, calendar information for the first entity, and/or other attributes associated with the first entity. More details describing the support ticket assignment engine 110 will be provided below in reference to FIG. 2.

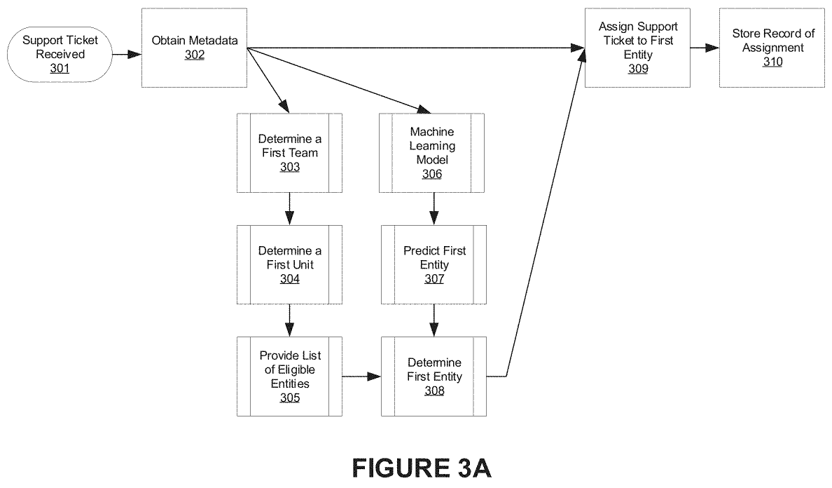

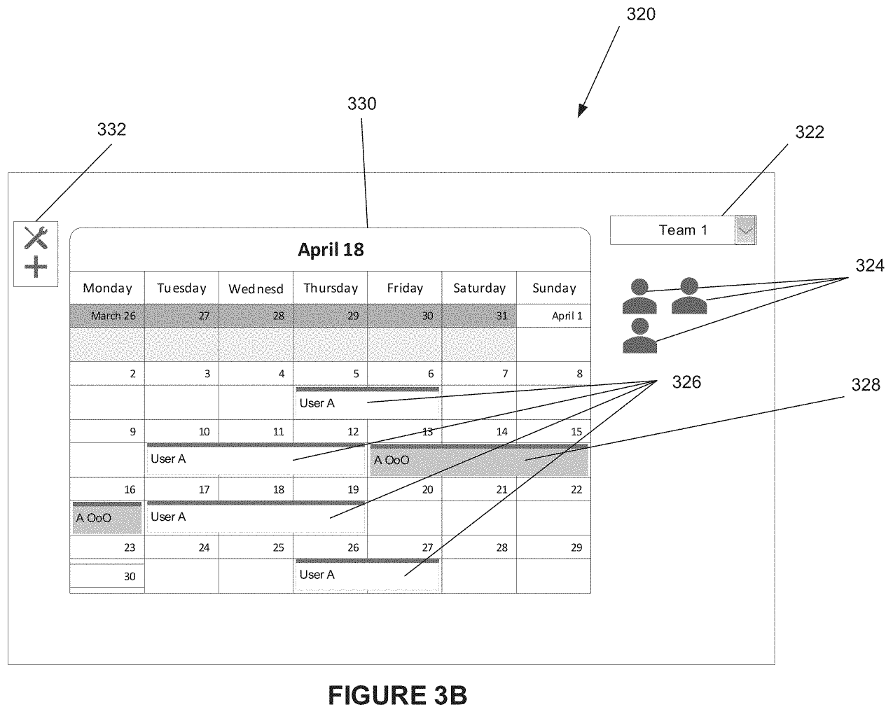

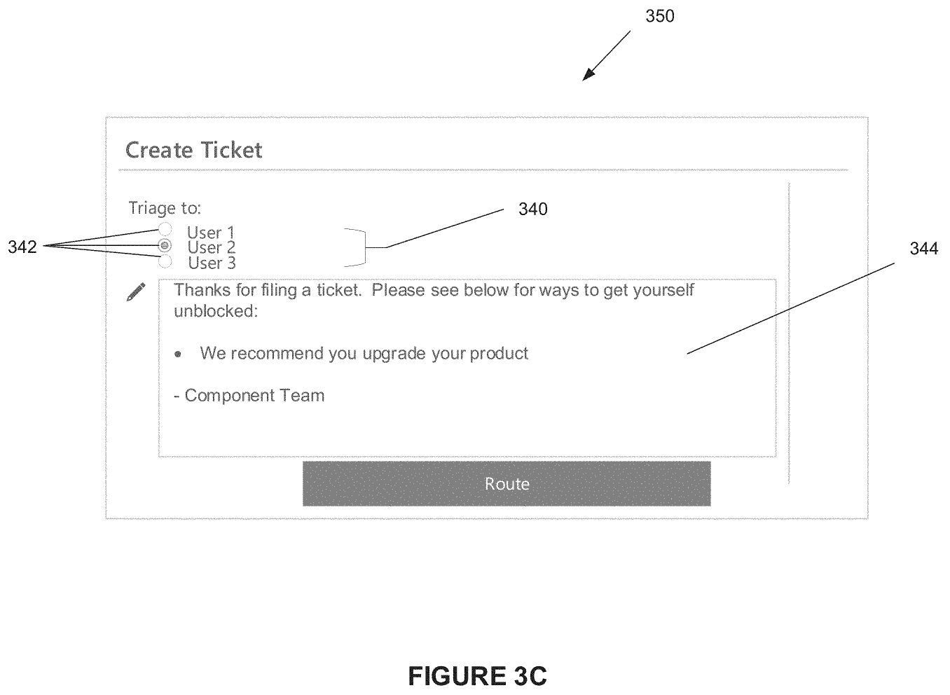

In some embodiments, the support ticket assignment engine 110 may be configured to provide an interface (e.g., graphical user interface) through which various information may be visualized, entered, and/or selected. For example, the interface may be provided by a software application (e.g., support ticket routing application, web browser, etc.) running on a computing device 120 and through a display screen of the computing device 120. The interface may provide users with the ability to enter and/or select a work schedule (e.g., which days and/or times a user is working or on the clock) and calendar information (e.g., information indicating one or more calendar events such as meetings, out of the office notifications, appointments, and/or other calendar events), view one or more entities eligible for assignment, and/or select one or more entities to which the support ticket should be assigned. For example, a user operating the computing device 120 may interact with the interface to view and/or select one or more entities. More details describing the interface are provided below in reference to FIG. 3B and FIG. 3C. In some embodiments, the interface provided by the support ticket assignment engine 110 includes an option for submitting (or uploading) documents that include information corresponding to a work schedule and/or calendar information.

Support ticket assignment engine 110 may implement various functionality of a support ticket assignment system as described in reference to FIGS. 3A-3C. In some embodiments, the support ticket assignment engine 110 may interact with a support ticket routing system that operates as described in reference to FIGS. 3A-3C. For example, in some embodiments, the support ticket assignment engine 110 may route support tickets based on the metadata information. These support tickets may be managed by the support ticket routing system (e.g., an enterprise support ticket platform) and may reference data stored in various data sources including, for example, the data stores 130. The support ticket assignment engine 110 may determine and/or identify one or more entities to assign the support ticket(s) to based on the metadata information corresponding to the support ticket(s) and respective attributes associated with the entities. For example, in some embodiments, the support ticket assignment engine 110 may search for and identify at least one entity that has one or more respective attributes which match or correspond to the metadata information corresponding to the received support ticket(s). The at least one entity identified may be provided to a team leader and/or other entity as a recommendation or suggested assignment. In some embodiments, multiple entities may be eligible for assignment to a given support ticket. In some instances, the support ticket assignment engine 110 may be configured to provide a list of the one or more entities that are eligible for assignment and determine a user selection of the entity to assign a given support ticket to.

FIG. 2 illustrates an example support ticket assignment engine 202, in accordance with various embodiments. The support ticket assignment engine 202 may be implemented as the support ticket assignment engine 110 of FIG. 1. In some embodiments, the support ticket assignment engine 202 includes a team engine 204, a unit engine 206, an entity engine 208, and a machine learning engine 210.

In various embodiments, the team engine 204 may be configured to determine a first team based, at least in part, on metadata information corresponding to a given support ticket and respective attributes associated with the first team. In some embodiments, team engine 204 may be configured to manage team information that describes teams that are available for support ticket assignment. The first team may be made up of one or more units (e.g., sub-teams) and/or one or more entities (e.g., personnel, resources, support engineers, etc.). For example, the first team may include a number of units, and each unit may include a number of entities. The first team may be responsible for supporting one or more products and/or components of one or more products. The respective attributes associated with the first team may include one or more of support issue types handled by the first team, one or more priorities (e.g., urgent, high level, low level, and/or other priorities) handled by the first team (i.e., one or more priorities the first team is able to address or does address), one or more products or components handled by the first team, the product or component version(s) handled by the first team, a security level clearance of the first team, one or more units within the first team, one or more entities belonging to the first team, and/or other attributes associated with the first team. The first team may include a first user and/or other users.

In some embodiments, the unit engine 206 may be configured to determine a first unit based at least in part on the metadata information corresponding to the support ticket and respective attributes associated with the first unit. The unit engine 206 may be configured to manage unit information describing one or more units within the one or more teams. In various embodiments, one or more units may be part of a team and include a number of entities. For example, a team may include multiple units and each unit may be tasked with processing support tickets that originate from one or more particular time zones. Many variations are possible. The respective attributes associated with the first unit may include one or more of support issue types handled by the first unit, one or more priorities handled by the first unit, one or more products or components handled by the first unit, the product or component version(s) handled by the first unit, a security level of the first unit, one or more entities belonging to the first unit, a geographical location associated with the first unit, a time zone associated with the first unit, and/or other attributes associated with the first unit. The first unit may include the first user and/or other users. Many variations are possible.

The entity engine 208 may be configured to store one or more records of support ticket(s) being assigned to one or more entities. For example, the entity engine 208 may store a record of a support ticket being assigned to a first entity responsive to the support ticket being assigned to at least the first entity. In some embodiments, the entity engine 208 may control and/or determine which entity, from a list of one or more entities that are eligible for assignment, to recommend (e.g., via initial selection that a user may override) for assignment. In some embodiments, the entity engine 208 may alternate among the one or more entities that are eligible for assignment. For example, responsive to a first entity and a second entity being eligible for assignment, a first support ticket may be assigned to the first entity, a second support ticket may be assigned to the second entity, and a third support ticket may again be assigned to the first entity. In some embodiments, the entity engine 208 may determine one or more entities that should be assigned a support ticket based on user settings and/or preferences, a quantity of unresolved support tickets in an entity's queue, the entity's work schedule information, the entity's calendar information, support issue types handled by the entity, one or more priorities handled by the user, one or more products or components handled by the entity, the product or component version(s) handled by the user, a security level of the entity, a unit the entity belongs to, a team the entity belongs to, time zone information for the entity, geographical location information for the entity, and/or other information.

The machine learning engine 210 may be configured to determine a team, unit, and/or entity to which a given support ticket should be assigned based at least in part on a machine learning model. The machine learning model may be trained using a set of examples. Individual examples within the set of examples may include a set of metadata values provided for a given support ticket as inputs, and/or information describing one or more teams, units, and/or entities to which the support ticket was previously assigned as a supervisory signal. In various embodiments, the trained machine learning model may be configured to output a prediction for assigning a given support ticket to a given team, unit, and/or entity based at least in part on metadata values associated with the support ticket. The metadata values may include at least one of a support issue type, priority, product or component affected, product or component version, security level requirement, and a description of a problem to be addressed by the support ticket. For example, if the metadata values for multiple support tickets indicate a first component problem, a first priority, and/or an intake time of 9:30 a.m. EST, and the multiple support tickets are assigned to a first entity and/or a second entity within a first unit within a first team, the machine learning model may be configured to output a prediction (e.g., indicating assignment to the first entity and/or the second entity) for a support ticket having similar metadata values.

For example, and referring to FIG. 3A, a process 300 for routing a support ticket may include receiving the support ticket at 301. Metadata corresponding to the support ticket may be obtained at 302. In some embodiments, responsive to obtaining the metadata at 302, a first team may be determined based on the obtained metadata and one or more attributes of the first team at 303. Next, a first unit within the first team may be determined based on the metadata at 304 and one or more attributes of the first unit. In some embodiments, a list of eligible entities within the first unit may be provided at 305. In such embodiments, the first entity may be determined at 308, for example, based on a user selection from the list of eligible entities. Once selected, the support ticket may be assigned to the first entity at 309 and a record of the assignment may be stored at 310. In some embodiments, responsive to receiving the metadata at 302, the metadata may be processed by a machine learning model at 306. A first entity may be predicted by the machine learning model at 307. The first entity may be determined at 308 based on the prediction. After determining the first entity, the support ticket may be assigned to the first entity at 309. Further, a record of the assignment may be stored at 310. Many variations or combinations of the embodiments described herein are contemplated and incorporated herein.

In various implementations, support ticket assignment engine 202 may be configured to effectuate presentation of a graphical user interface for receiving and/or displaying calendar information and schedule information for one or more entities. For example, in FIG. 3B, calendar interface 320 may effectuate presentation of calendar information and work schedule information for one or more entities, units, and/or teams. A team and/or unit may be selected via a drop down menu 322. One or more entities 324 that are included in and/or belong to the team or unit selected via drop down menu 322 may be displayed in one or more fields within calendar interface 320. Work schedule information 326 and calendar information 328 for entities 324 may be included within a calendar field 330. In some embodiments, calendar field 330 may comprise a schedule field displaying work schedule information 326 for one or more days and/or portions of days. In some embodiments, one or more scheduling tools 332 may be provided via calendar interface 320. One or more entities, unit leaders, and/or team leaders may enter the calendar information 328 and the work schedule information 326 for one or more entities 324. The one or more entities, unit leaders, and/or team leaders may visualize the calendar information 328 and the work schedule information 326 for one or more entities by filtering by team and/or unit via drop down menu 322. The work schedule information 326 for one or more entities 324 may include the hours and/or days the entity will be working and/or available to respond to support tickets. The calendar information 328 for one or more entities 324 may include one or more out of office dates, scheduled meetings during which entities cannot respond to support tickets, and/or other calendar events that indicate an entity may be unavailable. The entities may correspond to one or more support users that respond to and/or resolve support tickets.

Support ticket assignment engine 202 may be configured to provide a list of one or more entities that are eligible for assignment based on the metadata. User selection of one or more entities from the list of eligible entities may be determined (e.g., received, obtained, and/or otherwise determined). The user selection may be through an interface. For example, and referring to FIG. 3C, example interface 350 may comprise at least a list of entities 340 eligible for assignment based on the metadata, one or more selection fields 342 enabling election of one or more of the entities in the list of entities 340, a notification message 344 notifying the eligible user that he or she has been assigned to the support ticket, the support ticket which may or may not include the metadata in a readable format, and/or other features. One or more of selection fields 342 may be automatically selected (e.g., as a recommendation) based on the metadata, the machine learning model, user preferences or rules, or other parameters. For example, if the previous support ticket was assigned to “User 1,” “User 2” may be initially suggested for assignment on the next support ticket. By way of another example, “User 1” may have multiple open trouble tickets assigned to them already (e.g., because they were the only eligible user up until “User 2”, in another time zone, became available), so “User 2” may initially be suggested for assignment. A user may select a different one and/or additional ones of entities in the list of entities 340, besides the initial suggestion, to assign the support ticket to. Responsive to the user selecting the “route” button 348, the support ticket may be assigned to the selected entity (e.g., “User 2”).

### Example Flowcharts of Process

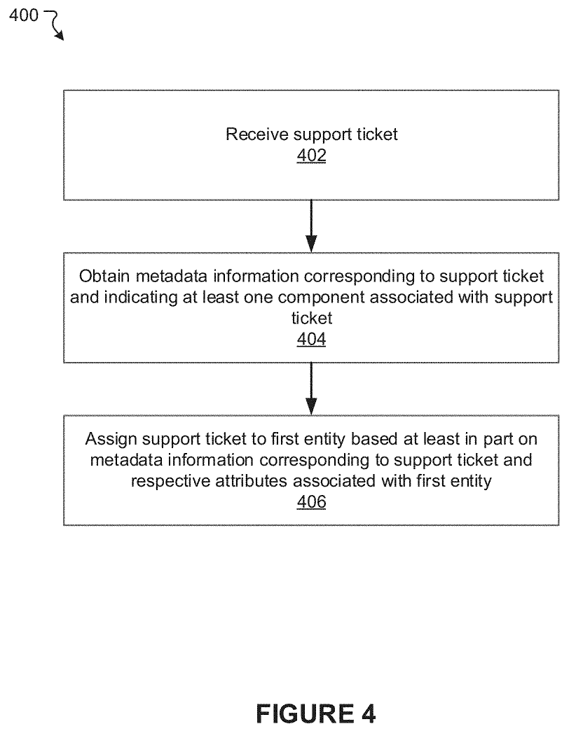

FIG. 4 depicts a flowchart of an example method 400 for routing support tickets, in accordance with various embodiments. The operations of method 400 presented below are intended to be illustrative and, as such, should not be viewed as limiting. In some implementations, method 400 may be accomplished with one or more additional operations not described, and/or without one or more of the operations discussed. In some implementations, two or more of the operations may occur substantially simultaneously. The described operations may be accomplished using some or all of the system components described herein.

In an operation 402, method 400 may include receiving a support ticket. In some implementations, operation 402 may be performed by a component the same as or similar to user support ticket engine 106 (shown in FIG. 1 and described herein).

In an operation 404, method 400 may include obtaining metadata information corresponding to support ticket. The metadata information may indicate at least one component associated with the support ticket. In some embodiments, the component associated with the support ticket may be the component a user needs support for. Metadata information may include one or more metadata values comprising at least one of a support issue type, priority, product or component affected, product or component version, security level requirement, and/or description of a problem to be addressed by the support ticket. In some implementations, operation 404 may be performed by a component the same as or similar to metadata engine 108 (shown in FIG. 1 and described herein).

In an operation 406, method 400 may include assigning the support ticket to at least the first entity based at least in part on the metadata information corresponding to support ticket and respected attributes associated with the first entity. The respected attributes associated with the first entity may include time zone information, geographical location information, work schedule information, and/or calendar information for the first entity. In some embodiments, assigning the support ticket to the first entity may include providing a list of one or more entities that are eligible for assignment including the first entity, determining a user selection of the first entity through an interface, and/or storing a record of the support ticket being assigned to the first entity. In some implementations, operation 406 may be performed by a component the same as or similar to support ticket assignment engine 110 (shown in FIG. 1 and described herein).

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

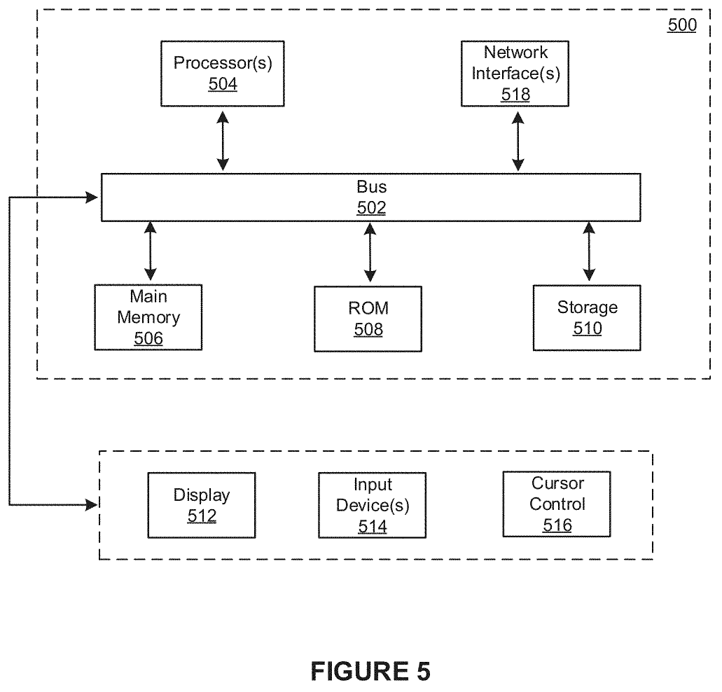

FIG. 5 depicts a block diagram of an example computer system 500 in which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a cathode ray tube (CRT) or LCD display (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C, or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media may also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer may load the instructions into its dynamic memory and send the instructions over a telephone line using a modem. A modem local to computer system 500 may receive the data on the telephone line and use an infra-red transmitter to convert the data to an infra-red signal. An infra-red detector may receive the data carried in the infra-red signal and appropriate circuitry may place the data on bus 502. Bus 502 carries the data to main memory 506, from which processor 504 retrieves and executes the instructions. The instructions received by main memory 506 may retrieves and executes the instructions. The instructions received by main memory 506 may optionally be stored on storage device 510 either before or after execution by processor 504.

The computer system 500 also includes a communication interface 518 coupled to bus 502. Communication interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicated with a WAN). Wireless links may also be implemented. In any such implementation, communication interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 may send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention may be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Engines, Components, and Logic

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines may provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment may be combined with one or more features of any other embodiment.

Other implementations, uses and advantages of the invention will be apparent to those skilled in the art from consideration of the specification and practice of the invention disclosed herein. The specification should be considered to describe examples only, and the scope of the invention is accordingly intended to be limited only by the following claims.

What is claimed is:

1. A system for routing support tickets, the system comprising:
one or more processors; and
a memory storing instructions that, when executed by the one or more processors, cause the system to:
receive a support ticket;
obtain metadata information corresponding to the support ticket, the metadata information indicating at least one component associated with the support ticket; and
assign the support ticket to at least a first entity based at least in part on the metadata information corresponding to the support ticket and respective attributes associated with the first entity.

2. The system of claim 1, wherein assigning the support ticket further causes the system to:
provide a list of one or more entities that are eligible for assignment, the one or more entities including the first entity;
determine a user selection of the first entity through an interface; and
store a record of the support ticket being assigned to the first entity.

3. The system of claim 1, wherein assigning the support ticket further causes the system to: determine the first entity based at least in part on a machine learning model.

4. The system of claim 3, wherein the machine learning model is trained using a set of training examples that each include a set of metadata values provided for a given support ticket as inputs, and information describing one or more entities or teams to which the support ticket was assigned as a supervisory signal.

5. The system of claim 3, wherein the machine learning model outputs a prediction for assigning the support ticket to the first entity based at least in part on metadata values associated with the support ticket.

6. The system of claim 1, wherein the metadata values include at least one of a support issue type, priority, product or component affected, product or component version, security level requirement, and a description of a problem to be addressed by the support ticket.

7. The system of claim 1, wherein attributes associated with entities include time zone information, geographical location information, work schedule information, and/or calendar information.

8. The system of claim 1, wherein assigning the support ticket further causes the system to:
determine a first team based at least in part on the component associated with the support ticket and respective attributes associated with the first team;
provide a list of one or more entities within the first team that are eligible for assignment, the one or more entities including the first entity;
determine a user selection of the first entity through an interface; and
store a record of the support ticket being assigned to the first entity.

9. The system of claim 1, wherein assigning the support ticket further causes the system to:
determine a first team based at least in part on the metadata information corresponding to the support ticket and respective attributes associated with the first team;
determine a first unit based at least in part on the metadata information corresponding to the support ticket and respective attributes associated with the first unit;
provide a list of one or more entities within the first unit that are eligible for assignment, the one or more entities including the first entity;
determine a user selection of the first entity through an interface; and
store a record of the support ticket being assigned to the first entity.

10. The system of claim 1, wherein the respective attributes associated with the first unit include one or both of a geographical location and a time zone associated with the first unit.

11. A computer-implemented method for routing support tickets, the method being performed on a computer system having one or more physical processors programmed with computer program instructions that, when executed by the one or more physical processors, cause the computer system to perform the method, the method comprising:
receiving a support ticket;
obtaining metadata information corresponding to the support ticket, the metadata information indicating at least one component associated with the support ticket; and
assigning the support ticket to at least a first entity based at least in part on the metadata information corresponding to the support ticket and respective attributes associated with the first entity.

12. The method of claim 11, wherein assigning the support ticket further comprises:
providing a list of one or more entities that are eligible for assignment, the one or more entities including the first entity;
determining a user selection of the first entity through an interface; and
store a record of the support ticket being assigned to the first entity.

13. The method of claim 11, wherein assigning the support ticket further comprises determining the first entity based at least in part on a machine learning model.

14. The method of claim 13, wherein the machine learning model is trained using a set of training examples that each include a set of metadata values provided for a given support ticket as inputs, and information describing one or more entities or teams to which the support ticket was assigned as a supervisory signal.

15. The method of claim 13, wherein the machine learning model outputs a prediction for assigning the support ticket to the first entity based at least in part on metadata values associated with the support ticket.

16. The method of claim 11, wherein the metadata values include at least one of a support issue type, priority, product or component affected, product or component version, security level requirement, and a description of a problem to be addressed by the support ticket.

17. The method of claim 11, wherein attributes associated with entities include time zone information, geographical location information, work schedule information, and/or calendar information.

18. The method of claim 11, further comprising:
determining a first team based at least in part on the component associated with the support ticket and respective attributes associated with the first team;
providing a list of one or more entities within the first team that are eligible for assignment, the one or more entities including the first entity;
determining a user selection of the first entity through an interface; and
storing a record of the support ticket being assigned to the first entity.

19. The method of claim 11, further comprising:
determining a first team based at least in part on the component associated with the support ticket and respective attributes associated with the first team;
determining a first unit based at least in part on the metadata information corresponding to the support ticket and respective attributes associated with the first unit;
providing a list of one or more entities within the first unit that are eligible for assignment, the one or more entities including the first entity;
determining a user selection of the first entity through an interface; and
storing a record of the support ticket being assigned to the first entity.

20. The system of claim 11, wherein the respective attributes associated with the first unit include one or both of a geographical location and a time zone associated with the first unit.
